(19) United States
(12) Patent Application Publication
(10) Pub. No.: US 2024/0205985 A1
(43) Pub. Date: Jun. 20, 2024

(54) Radio Network Service Configuration Method, Terminal, and Network Side Device

(71) Applicant: VIVO MOBILE COMMUNICATION CO., LTD., Dongguan (CN)

(72) Inventors: Yannan Yuan, Dongguan (CN); Xiaodong Yang, Dongguan (CN); Chenlu Zhang, Dongguan (CN)

(21) Appl. No.: 18/593,017

(22) Filed: Mar. 1, 2024

Related U.S. Application Data
(63) Continuation of application No. PCT/CN2022/115873, filed on Aug. 30, 2022.

(30) Foreign Application Priority Data
Sep. 2, 2021 (CN) 202111027750.4

(51) Int. Cl. H04W 76/10; H04W 76/34

(52) U.S. Cl. CPC H04W 76/10; H04W 76/34

(57) ABSTRACT

A radio network service configuration method includes executing, by a first function, a first behavior according to first information, where the first function belongs to a first network function or a first network element, the first behavior includes at least one of establishing a radio service channel, reconfiguring a radio service channel, mapping the first information to an established radio service channel, or releasing a radio service channel, and the radio service channel includes at least one network function and/or at least one network function instance in a radio access network.

### CROSS-REFERENCE TO RELATED APPLICATIONS

This application is a Bypass Continuation Application of International Patent Application No. PCT/CN2022/115873, filed Aug. 30, 2022, and claims priority to Chinese Patent Application No. 202111027750.4, filed Sep. 2, 2021, the disclosures of which are hereby incorporated by reference in their entireties.

### BACKGROUND OF THE INVENTION

### Field of the Invention

This application pertains to the field of wireless communication technologies, and specifically relates to a radio network service configuration method, a terminal, and a network side device.

### Description of Related Art

With continuous development of wireless communication technologies, a vision of a 6th generation (6G) mobile network is dedicated to constructing a new type of network with intelligent interconnection of man, machine and, object and efficient interconnection of intelligent agents. For example, on the basis of significantly improving a network capability, a radio network can have new features such as smart endogens, multidimensional perception, digital twin, and endogens security.

Therefore, how to further improve service flexibility of a radio access network and make the radio access network easy to expand a new function becomes an urgent problem to be resolved nowadays.

### SUMMARY OF THE INVENTION

According to a first aspect, a radio network service configuration method is provided, including: executing, by a first function, a first behavior according to first information, where the first function belongs to a first network function or a first network element, the first behavior includes at least one of establishing a radio service channel, reconfiguring a radio service channel, mapping the first information to an established radio service channel, or releasing a radio service channel, and the radio service channel includes at least one network function and/or at least one network function instance in a radio access network.

According to a second aspect, a radio network service configuration method is provided. The method includes: sending, by a terminal, a second message to a first function when receiving a first message sent by the first function, where the first function belongs to a first network function or a first network element, and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the terminal has established a radio service channel corresponding to the radio service channel configuration information; a radio service channel reconfiguration complete message, used to indicate that the terminal has reconfigured a radio service channel corresponding to the radio service channel reconfiguration information; or a radio service channel reject message, used to indicate that the terminal has rejected the radio service channel configuration information or the radio service channel reconfiguration information.

According to a third aspect, a radio network service configuration method is provided. The method includes: sending, by a first object, a second message to a first function or a terminal when receiving a first message sent by the first function, where the first object includes a second network function or a second network element; and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the first object has established a radio service channel corresponding to the radio service channel configuration information; a radio service channel reconfiguration complete message, used to indicate that the first object has reconfigured a radio service channel corresponding to the radio service channel reconfiguration information; or a radio service channel reject message, used to indicate that the first object has rejected the radio service channel configuration information or the radio service channel reconfiguration information.

According to a fourth aspect, a radio network service configuration apparatus is provided. The apparatus includes an execution module, configured to execute a first behavior according to first information by using a first function, where the first function belongs to a first network function or a first network element, the first behavior includes at least one of establishing a radio service channel, reconfiguring a radio service channel, mapping the first information to an established radio service channel, or releasing a radio service channel, and the radio service channel includes at least one network function and/or at least one network function instance in a radio access network.

According to a fifth aspect, a radio network service configuration apparatus is provided and is applied to a terminal. The apparatus includes: a first transmission module, configured to send a second message to a first function in a case that a first message sent by the first function is received, where the first function belongs to a first network function or a first network element, and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the terminal has established a radio service channel corresponding to the radio service channel configuration information; a radio service channel reconfiguration complete message, used to indicate that the terminal has reconfigured a radio service channel corresponding to the radio service channel reconfiguration information; or a radio service channel reject message, used to indicate that the terminal has rejected the radio service channel configuration information or the radio service channel reconfiguration information.

According to a sixth aspect, a radio network service configuration apparatus is provided, applied to a first object. The apparatus includes: a second transmission module, configured to send a second message to a first function or a terminal in a case that a first message sent by the first function is received, where the first object includes a second network function or a second network element; and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the first object has established a radio service channel corresponding to the radio service channel configuration information; a radio service channel reconfiguration complete message, used to indicate that the first object has reconfigured a radio service channel corresponding to the radio service channel reconfiguration information; or a radio service channel reject message, used to indicate that the first object has rejected the radio service channel configuration information or the radio service channel reconfiguration information.

According to a seventh aspect, a terminal is provided. The terminal includes a processor, a memory, and a program or an instruction that is stored in the memory and executable on the processor, and the program or the instruction is executed by the processor to implement the steps of the method according to the second aspect.

According to an eighth aspect, a terminal is provided, including a processor and a communication interface. The communication interface is coupled to the processor, and the processor is configured to run a program or an instruction to implement the steps of the method according to the second aspect.

According to a ninth aspect, a network side device is provided. The network side device includes a processor, a memory, and a program or an instruction that is stored in the memory and executable on the processor, and the program or instruction is executed by the processor to implement the steps of the method according to the first aspect or the steps of the method according to the third aspect.

According to a tenth aspect, a network side device is provided, including a processor and a communication interface. The communication interface is coupled to the processor, and the processor is configured to run a program or an instruction to implement the steps of the method according to the first aspect or the steps of the method according to the third aspect.

According to an eleventh aspect, a non-transitory readable storage medium is provided. The non-transitory readable storage medium stores a program or an instruction, and the program or the instruction is executed by a processor to implement the steps of the method according to the first aspect, the second aspect, or the third aspect.

According to a twelfth aspect, a chip is provided. The chip includes a processor and a communication interface, the communication interface is coupled to the processor, and the processor is configured to run a program or an instruction to implement the steps of the method according to the first aspect, or the steps of the method according to the second aspect, or the steps of the method according to the third aspect.

According to a thirteenth aspect, a computer program product/program product is provided. The computer program/program product is stored in a non-transient storage medium, and the program/program product is executed by at least one processor to implement the steps of the method according to the first aspect, the steps of the method according to the second aspect, or the steps of the method according to the third aspect.

### BRIEF DESCRIPTION OF THE DRAWINGS

FIG. 1 is a schematic structural diagram of a wireless communication system according to an embodiment of this application;

FIG. 2 is a first schematic flowchart of a radio network service configuration method according to an embodiment of this application;

FIG. 3 is a second schematic flowchart of a radio network service configuration method according to an embodiment of this application;

FIG. 4A is a first schematic interaction flowchart of a radio network service configuration method according to an embodiment of this application;

FIG. 4B is a second schematic interaction flowchart of a radio network service configuration method according to an embodiment of this application;

FIG. 4C is a third schematic interaction flowchart of a radio network service configuration method according to an embodiment of this application;

FIG. 5A is a third schematic flowchart of a radio network service configuration method according to an embodiment of this application;

FIG. 5B is a fourth schematic interaction flowchart of a radio network service configuration method according to an embodiment of this application;

FIG. 5C is a fifth schematic interaction flowchart of a radio network service configuration method according to an embodiment of this application;

FIG. 6 is a fourth schematic flowchart of a radio network service configuration method according to an embodiment of this application;

FIG. 7 is a fifth schematic flowchart of a radio network service configuration method according to an embodiment of this application;

FIG. 8 is a first schematic structural diagram of a radio network service configuration apparatus according to an embodiment of this application;

FIG. 9 is a second schematic structural diagram of a radio network service configuration apparatus according to an embodiment of this application;

FIG. 10 is a third schematic structural diagram of a radio network service configuration apparatus according to an embodiment of this application;

FIG. 11 is a schematic structural diagram of a terminal according to an embodiment of this application; and

FIG. 12 is a schematic structural diagram of a network side device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access, Time Division Multiple Access, Frequency Division Multiple Access (FDMA), Orthogonal Frequency Division Multiple Access (OFDMA), single-carrier frequency division multiple access (SC-FD-MA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6G communication system.

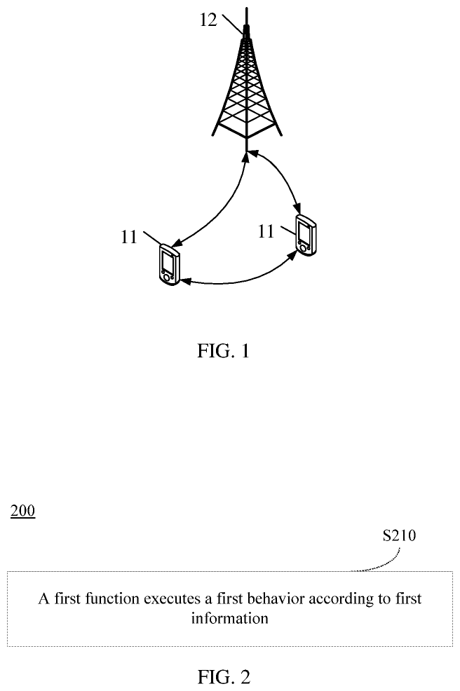

FIG. 1 is a schematic structural diagram of a wireless communication system to which the embodiments of this application can be applied. The wireless communication system includes a terminal 11 and a network side device 12. The terminal 11 may also be referred to as a terminal device or user equipment (UE). The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device MID), a wearable device, vehicle user equipment (VUE), or pedestrian user equipment (PUE). The wearable device includes: a smart watch, a wristband, a headset, and glasses. It should be noted that a specific type of the terminal 11 is not limited in the embodiments of this application. The network side device 12 may be a base station or a core network. The base station may be referred to as an access point, a base transceiver station (BTS), a radio base station, a radio transceiver, a basic service set (BSS), an extended service set (ESS), a NodeB, an evolved NodeB (eNB), a home NodeB, a home evolved NodeB, a wireless local area network (WLAN) access point, a wireless fidelity (Wi-Fi) node, a transmission reception point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

The technical solutions provided in the embodiments of this application are described in detail below with reference to the accompanying drawings by using some embodiments and application scenarios thereof.

FIG. 2 is a schematic flowchart of a radio network service configuration method 200 according to an example embodiment of this application. The method 200 may be performed by, but not limited to, a first function in a first network element or a first function in a first network function, and may be performed by hardware and/or software installed in the first network element or the first network function. In this embodiment, the method may include at least the following step.

S210. A first function executes a first behavior according to first information.

The first function may also be referred to as a radio service channel control function (RSCCF), a channel control function, a radio management function, or the like, and is used to allocate an identifier of a radio service channel (RSC), establish a radio service channel, reconfigure a radio service channel, release a radio service channel, and the like.

It can be understood that the first function may be a network function (NF) (for example, xNF). For example, the first function may belong to a first network function (for example, xNF) or a first network element (for example, xNB). Alternatively, the first function may be understood as a network side device such as a first network function or a first network element. In this case, assuming that the first function is a network function, interaction between the first function or the first network function/the first network element to which the first function belongs and another network function other than the first network function/the first network element may be used to complete configuration of a radio service channel on a network side, for example, reconstruction of an existing network function, thereby improving implementation and deployment efficiency of a network function or a network element at a radio access layer. It should be noted that the foregoing interaction information may be transparent to a terminal.

Alternatively, direct or indirect interaction between the first function or the first network function/the first network element to which the first function belongs and the terminal may be used to complete protocol consistency processing between the network side and the terminal. The interaction information may affect the terminal, for example, information about a newly introduced network function or a network function combination that needs to be configured by using the terminal, so that the terminal supports the new network function and/or the network function combination.

Certainly, considering that this application is implemented based on a concept of a radio access network service architecture, for example, in a radio access network, network functions of the radio access network can exchange information flexibly through a service bus, or the like, the radio service channel mentioned in this embodiment is implemented by flexibly combining network functions at a radio access layer, for example, a combination of radio protocol processing functions from an upper layer to an air interface such as processing signaling and/or user surface data in a certain order, so that the radio access layer can support different air interface services, and protocol functions (for example, a service data adaptation protocol, a packet data convergence protocol (PDCP), a non-access stratum (NAS), radio resource control (RRC) in the radio access network are configured as required.

In an implementation, in this embodiment, a radio service channel may be represented in two dimensions. One is a composition of a network function in the radio service channel and a sequence relationship between network functions. The other is composition information of a network function instance of the radio service channel and a sequence relationship between network function instances. That is, the radio service channel includes at least one network function and/or at least one network function instance in the radio access network.

When flexible combination of the radio service channel is performed, a physical layer function used by an air interface is mandatory, and another function is optional. In addition, considering that a higher frequency such as THz needs to be introduced into 6G in the future, in some cases, if physical layer resources are sufficient, processing efficiency may be a principle of performing flexible combination of the radio service channel. Based on this, a potential simplified radio service channel is that when a constraint of a maximum size of a data block transmitted on an air interface is met, radio link control (RLC) unpacking/packing and medium access control (MAC) multiplexing/demultiplexing are not required, and transmission at the physical layer is performed according to data of an upper layer.

It should be noted that, a 6G network architecture is used as an example. If a 6G radio access network provides user plane and control plane protocol termination points for the terminal by using an NR NodeB (gNB), and is connected to a core network by using core network and radio access network interfaces, the first function may be one of control plane functions of the radio access network node. If the 6G radio access network provides user plane and control plane protocol termination points for the terminal through coordination of a macro cell node and a micro cell node, the first function may be one of functions of the macro cell node, and radio service channel control may be performed on a micro cell NodeB and/or the terminal in a range in which the macro cell node is located. In addition, if 6G uses a service configuration scheme in which the core network is integrated with the radio access network, the first function may be one of service configuration functions integrated by the core network and the radio access network. This is not specifically limited.

Based on the foregoing descriptions of the first function and the radio service channel, the first behavior executed by the first function according to the first information may include: determining, by the first function, a protocol processing function of the radio access network according to the first information, and then establishing a radio service channel, reconfiguring a radio service channel, mapping the first information to an established radio service channel, and releasing a radio service channel according to a result of the determining. That is, the first behavior may include at least one of establishing a radio service channel, reconfiguring a radio service channel, mapping the first information to an established radio service channel, or releasing a radio service channel, to configure the radio service channel as required.

Correspondingly, the first information may be user requirement information, control plane requirement information, a terminal request, or the like. This is not limited herein.

In this embodiment, the first function establishes, reconfigures, and releases a radio service channel according to the first information. Therefore, a flexible combination of network functions at the radio network layer from the upper layer to the physical layer and multiplexing of network function instances can be implemented, so that the radio access layer can support air interface services of different requirements.

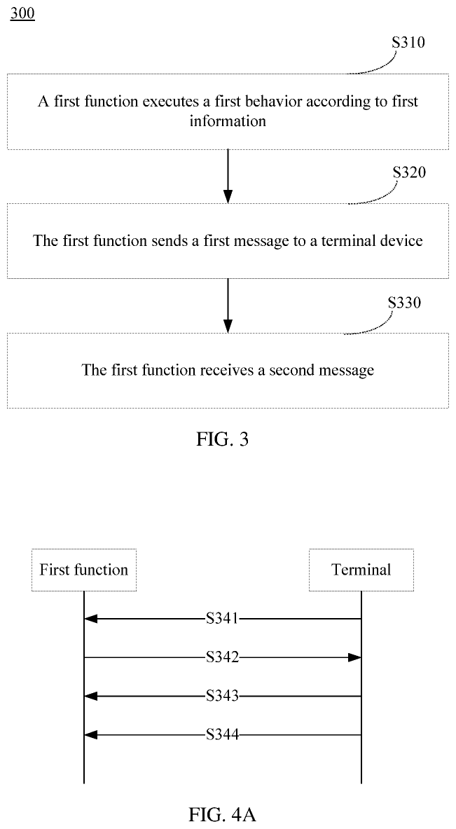

FIG. 3 is a schematic flowchart of a radio network service configuration method 300 according to an example embodiment of this application. The method 300 may be performed by, but not limited to, a network side device, and may be performed by hardware and/or software installed in the network side device. In this embodiment, the method 300 may include at least the following steps.

S310. A first function executes a first behavior according to first information.

The first function belongs to a first network function or a first network element, the first behavior includes at least one of establishing a radio service channel, reconfiguring a radio service channel, mapping the first information to an established radio service channel, or releasing a radio service channel, and the radio service channel includes at least one network function and/or at least one network function instance in a radio access network.

It can be understood that, for an implementation process of S310, refer to the foregoing related descriptions of the method embodiment 200. In a possible implementation, the first information may include at least one of the following (11) to (14).

(11) User plane requirement information.

The user plane requirement information may include but is not limited to a protocol data unit (PDU) session, a quality of service (QoS) flow, and the like.

(12) Control plane requirement information.

The control plane requirement information may include but is not limited to a non-access stratum (NAS) message, a RRC message, or the like.

(13) Context information of each network function in a radio access network.

The context information of the network function (NF) may be implemented through a network repository function (NRF), such as registration, de-registration, discovery, modification, query, and maintenance of the network function.

In a case that a core network and the radio access network are separately serviced, the network repository function belongs to the radio access network, and registration, de-registration, discovery, modification, query, and creation of the network function serving the radio access network may be jointly or separately disposed with the first function. In a case that a core network and the radio access network are jointly serviced, the network repository function belongs to the core network, and therefore the NRF may support related information maintenance and interaction of the radio service channel based on NRF node evolution in a 5G core network.

Based on this, in this embodiment, the context information of the network function (which may also be referred to as description information of the network function) may include at least one of the following (131) to (137).

(131) A type of the network function, used to distinguish different network functions.

In this embodiment, the type of the network function may be a character type or a number. For example, when the type of the network function is a character type, the network function may be a packet data convergence protocol (PDCP), unacknowledged mode radio link control (UM RLC), acknowledged mode radio link control (AM RLC), or the like. For another example, when the type of the network function is a numeric type, “1” may represent a PDCP function, “2” represents AM RLC, and “3” represents UM RLC. This is not limited herein.

(132) An identifier of the network function instance.

When a plurality of same network function instances exist in network functions of a same network function identifier, the identifier is used to distinguish a plurality of network function instances of the network function. Optionally, the identifier may be a character type, a numeric type, or the like. This is not limited herein.

(133) An identifier of a radio service channel.

The radio service channel is related to the network function. For example, assuming that a network function A is included in a radio service channel B, a radio service channel related to the network function A is the radio service channel B.

(134) Capability information of the network function.

The capability information may be a PDCP throughput, an RRC maximum connection quantity, or the like.

(135) Location information of the network function.

The location information may be absolute location information, relative location information, or the like.

(136) Load information of the network function.

The load information may be resource utilization or the like.

(137) An identifier of the network function, used to register, search, and modify the corresponding network function.

It should be noted that, according to the context information of the network function, one network function may correspond to one or more radio service channels, such as {NF type 1 identifier, NF type 2 identifier, NF type 3 identifier}.

(14) A first request, where the first request is determined and sent by the terminal according to local information (for example, power information of the terminal, user personalized requirement information, and service requirement information), to request the first function to establish a radio service channel that meets a requirement, reconfigure a radio service channel, or release a radio service channel.

In this embodiment, information carried in the first request is different according to different requirements corresponding to the first request. The following is separately described, and content is as follows:

Implementation 1: in a case that the first request is used to request the first function to establish a radio service channel that meets the requirement, the first request may carry at least one of the following (1401) to (1405).

(1401) An identifier of the terminal, where the identifier is used for identification of the terminal.

(1402) A cause for requesting to establish the radio service channel, used to provide information such as a requirement (for example, QoS) and/or a service characteristic (for example, a packet size) of the radio service channel that needs to be established.

It should be noted that when the first request does not include the cause for requesting to establish the radio service channel, the first function may determine, according to obtained network function state information or the like, whether to allow or reject to establish the radio service channel.

(1403) Composition information of a network function included in the radio service channel that is requested to be established.

The information is used to indicate the network function included in the radio service channel.

Optionally, the information may be represented in a plurality of manners. For example, the information may be represented based on a network function type set consisting of network function types, for example, {NF type 1, NF type 2, NF type 3}, where NF type 1 represents header compression, NF type 2 represents Hybrid automatic repeat request (HARQ) error correction and priority scheduling, and NF type 3 represents a physical layer shared channel based on orthogonal frequency division multiplex (OFDM).

For another example, the information may be represented based on a function combination and an identifier predefined in a protocol. If the protocol defines that {NF type 1, NF type 2, NF type 3} is function composition information of a radio service channel whose identifier is 1, and {NF type 1, NF type 2, NF type 3} is function composition information of a radio service channel whose identifier is 2, the information may be used to represent the function composition information of the corresponding radio service channel by using the identifier 1 or the identifier 2.

(1404) A function sequence between network functions of the radio service channel that is requested to be established.

The information is used to indicate the function sequence of the radio service channel. It should be noted whether the function sequence is a transmit end sequence or a receive end sequence.

In an implementation, the information may be combined with the composition information of the network function included in the radio service channel in (1403), and the function composition and the function sequence are represented simultaneously by using one vector.

Similar to the foregoing (1403), the function sequence may be represented in a plurality of manners. For example, the sequence between functions constituting the radio service channel may be represented in a vector or list manner, such as {NF type 1, NF type 2, NF type 3}.

For another example, based on a function sequence (and/or a function composition) defined in a protocol. If the protocol defines that {NF type 1, NF type 2, NF type 3} is a function composition and a function sequence of a radio service channel whose identifier is 1, and {NF type 1, NF type 2, NF type 3} is a function composition and a function sequence of a radio service channel whose identifier is 2, the function composition and the function sequence of the corresponding radio service channel may be represented by using the identifier 1 or the identifier 2.

(1405) Whether the function sequence is a transmit end sequence or a receive end sequence.

For an implementation process of (1405), refer to the related descriptions in (1404). Details are not described herein again.

Implementation 2: in a case that the first request is used to request the first function to reconfigure a radio service channel, the first request may carry at least one of the following (1411) to (1422).

(1411) An identifier of the terminal, where the identifier is used for identification of the terminal.

(1412) A cause for requesting to reconfigure the radio service channel, used to provide a requirement (for example, QoS) and/or a service characteristic (for example, a packet size) of the radio service channel that needs to be to be reconfigured.

Optionally, when the first request does not include the cause for requesting to reconfigure the radio service channel, the first function may determine, according to obtained network function state information or the like, whether to allow or reject to reconfigure the radio service channel.

(1413) An identifier of the radio service channel that is requested to be reconfigured, used by the first function to identify the radio service channel that needs to be reconfigured.

(1414) A quantity of network functions included in the radio service channel that is requested to be reconfigured.

For example, assuming that the radio service channel includes five NFs and it is requested to reconfigure three NFs, the quantity in (1414) is 3.

(1415) A variation of the quantity of network functions in the radio service channel that is requested to be reconfigured.

For example, assuming that the radio service channel includes five NFs and it is requested to reconfigure three NFs, the variation in (1415) is 2, that is, a corresponding field is 2.

(1416) A function composition supported by the radio service channel.

The information is used to indicate a network function included in the radio service channel.

In an implementation, the information may be represented based on a network function type set consisting of network function types, for example, {NF type 1, NF type 2, NF type 3}, where NF type 1 represents header compression, NF type 2 represents HARQ error correction and priority scheduling, and NF type 3 represents a physical layer shared channel based on OFDM.

It should be noted that, when the radio service channel is reconfigured, the function composition in the radio service channel may be performed in cooperation with first indication information described in the following (1420).

(1417) Composition information of a network function included in the radio service channel that is requested to be reconfigured.

(1418) A function sequence between network functions of the radio service channel that is requested to be reconfigured.

(1419) Whether the function sequence is a transmit end sequence or a receive end sequence of target data.

For implementation processes of (1417) to (1419), refer to the related descriptions in (1403) to (1405). To avoid repetition, details are not described herein again.

(1420) First indication information, where the first indication information is used to indicate a network function reconfiguration type, and the network function reconfiguration type includes at least one of increasing a quantity of network functions in the radio service channel, reducing a quantity of network functions in the radio service channel, or modifying a network function in the radio service channel.

For example, “01” may represent increasing the quantity of network functions in the radio service channel, “10” may represent reducing the quantity of network functions in the radio service channel, and “00” may represent modifying one or more network functions in the radio service channel, and a quantity of network functions constituting the radio service channel changes or remains unchanged.

(1421) Second indication information, where the second indication information is used for indicating an information reconfiguration type, and the information reconfiguration type includes at least one of increasing a service data unit carried on the radio service channel, reducing a service data unit carried on the radio service channel, or modifying a service data unit carried on the radio service channel.

“01” may represent increasing a service data unit carried on the radio service channel, “10” represents reducing a service data unit carried on the radio service channel, and “00” represents modifying a service data unit carried on the radio service channel and a quantity of service data units carried on the radio service channel changes or remains unchanged.

(1422) Third indication information, where the third indication information is used to indicate a type of a service data unit carried on the radio service channel.

In an implementation, the type of the service data unit may be one or more of default, NAS signaling, an RRC message, a perception control message, perception data, a perception result, a digital twin control message, digital twin data, a data twin result, user plane data required by a quality of service requirement, and the like.

It should be noted that, when the radio service channel is reconfigured, the service data unit of the radio service channel may be implemented in cooperation with the foregoing second indication information.

Implementation 3: in a case that the first request is used to request the first function to release a radio service channel, the first request carries at least one of the following (1431) to (1433).

(1431) An identifier of the terminal, where the identifier is used for identification of the terminal.

(1432) A cause for requesting to release the radio service channel, where the information is used to provide a requirement (for example, QoS) and/or a service characteristic (for example, a packet size) of the radio service channel that needs to be released.

Optionally, when the first request does not include the cause for requesting to release the radio service channel, the first function may determine, according to obtained network function state information or the like, whether to allow or reject to release the radio service channel.

(1433) An identifier of the radio service channel that is requested to be released, used to identify the radio service channel.

S320. The first function sends a first message to a terminal.

The first message includes at least one of the following (21) to (24):

(21) Radio service channel configuration information, used to indicate that the first function has established a radio service channel corresponding to the first information.

In an implementation, the radio service channel configuration information may include at least one of the following (2101) to (2107).

(2101) An identifier of the radio service channel, used to identify the radio service channel, for example, used by the terminal to identify a radio service channel that needs to be established.

(2102) A quantity of network functions included in the radio service channel, used to indicate how many network functions the radio service channel includes.

A maximum quantity of network functions constituting the radio service channel depends on a total quantity of network functions defined by standardization and a mutually exclusive and cooperative relationship between network functions. In addition, for existing network function reconstruction and introduction of a new network function, a smaller granularity of a network function definition indicates a finer control capability of the first function on the radio service channel and a larger total quantity of corresponding network functions. When each defined network function has fixed processing, the network function does not need to be configured by using a control message (for example, an RLC UM whose sequence number (SN) length is 6 bits is one network function).

(2103) A function composition supported by the radio service channel, used to indicate a network function included in the radio service channel.

Optionally, the function composition supported by the radio service channel may be represented in a plurality of manners. For example, the function composition may be represented based on a network function type set consisting of network function types, for example, {NF type 1, NF type 2, NF type 3}, where NF type 1 represents header compression, NF type 2 represents HARQ error correction and priority scheduling, and NF type 3 represents a physical layer shared channel based on OFDM.

For another example, the function composition supported by the radio service channel may be represented based on a function combination and an identifier predefined in a protocol. If the protocol defines that {NF type 1, NF type 2, and NF type 3} is a function composition of a radio service channel whose identifier is 1, and {NF type 1, NF type 2, and NF type 3} is a function composition of a radio service channel whose identifier is 2, the function composition supported by the radio service channel may represent the function composition of the corresponding radio service channel by using the identifier 1 or the identifier 2.

(2104) A function sequence between network functions included in the radio service channel, used to indicate a function sequence of the radio service channel. It should be noted whether the sequence is a transmit end sequence or a receive end sequence.

Optionally, the function sequence may be represented in a plurality of manners. For example, the sequence between functions constituting the radio service channel may be represented in a vector or list manner, such as {NF type 1, NF type 2, NF type 3}.

For another example, based on a function sequence (and/or a function composition) defined in a protocol. If the protocol defines that {NF type 1, NF type 2, NF type 3} is a function composition and a function sequence of a radio service channel whose identifier is 1, and {NF type 1, NF type 2, NF type 3} is a function composition and a function sequence of a radio service channel whose identifier is 2, the function composition and the function sequence of the corresponding radio service channel may be represented by using the identifier 1 or the identifier 2.

(2105) Whether the function sequence is a transmit end sequence or a receive end sequence.

Refer to the related descriptions in (2104). To avoid repetition, details are not described herein again.

(2106) Composition information of a network function included in the radio service channel, used to indicate a network function included in the radio service channel.

(2107) Fourth indication information, where the fourth indication information is used to indicate a type of a service data unit carried on the radio service channel, and may be one or more of default, NAS signaling, an RRC message, a perception control message, perception data, a perception result, a digital twin control message, digital twin data, a data twin result, user plane data required by a service quality requirement, and the like.

(22) Radio service channel reconfiguration information, used to indicate that the first function has reconfigured a radio service channel corresponding to the first information.

In an implementation, the radio service channel reconfiguration information includes at least one of the following (2201) to (2206):

(2201) A quantity of network functions included in the radio service channel.

For example, assuming that the radio service channel includes five NFs and it is requested to reconfigure three NFs, the quantity in (1414) is 3.

(2202) Fifth indication information, where the fifth indication information is used to indicate a network function reconfiguration type, and the network function reconfiguration type includes at least one of increasing a quantity of network functions in the radio service channel, reducing a quantity of network functions in the radio service channel, or modifying a network function in the radio service channel.

For example, “01” may represent increasing the quantity of network functions in the radio service channel, “10” may represent reducing the quantity of network functions in the radio service channel, and “00” may represent modifying one or more network functions in the radio service channel, and a quantity of network functions constituting the radio service channel changes or remains unchanged.

(2203) A variation of the quantity of network functions in the radio service channel.

For example, assuming that the radio service channel includes five NFs and it is requested to reconfigure three NFs, the variation in (2203) is 2, that is, a corresponding field is 2.

(2204) A function composition supported by the radio service channel.

The information is used to indicate a network function included in the radio service channel.

In an implementation, the information may be represented based on a network function type set consisting of network function types, for example, {NF type 1, NF type 2, NF type 3}, where NF type 1 represents header compression, NF type 2 represents HARQ error correction and priority scheduling, and NF type 3 represents a physical layer shared channel based on OFDM.

It should be noted that, when the radio service channel is reconfigured, the function composition in the radio service channel may be performed in cooperation with the fifth indication information described in the above (2202).

(2205) Sixth indication information, where the sixth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel.

“01” may represent increasing a service data unit carried on the radio service channel, “10” represents reducing a service data unit carried on the radio service channel, and “00” represents modifying a service data unit carried on the radio service channel and a quantity of service data units carried on the radio service channel changes or remains unchanged.

(2206) Seventh indication information, where the seventh indication information is used to indicate a type of a service data unit carried on the radio service channel.

In an implementation, the type of the service data unit may be one or more of default, NAS signaling, an RRC message, a perception control message, perception data, a perception result, a digital twin control message, digital twin data, a data twin result, user plane data required by a quality of service requirement, and the like.

It should be noted that, when the radio service channel is reconfigured, the service data unit of the radio service channel may be implemented in cooperation with the foregoing second indication information.

(23) Radio service channel mapping information, used to indicate a mapping relationship between the first information and an established radio service channel.

For example, assuming that a radio service channel that matches the first information exists in the established radio service channel, or that the reconfigured radio service channel can match the first information (for example, the user plane requirement information, the control plane requirement information, or the first request), the first function may map the first information to the established radio service channel or the reconfigured radio service channel, and use the mapping relationship as the radio service channel mapping information.

(24) Radio service channel release information, used to indicate that the first function has released a radio service channel corresponding to the first information, where the radio service channel release information includes at least an identifier of the radio service channel.

It should be noted that before the sending the first message to the terminal, the first function may determine the first message according to second information. The second information includes at least one of the following (31) to (32):

(31) First configuration information, where the first configuration information is used for determining the first message, and the first configuration information is implemented through a protocol (for example, a standard protocol) stipulation, an upper layer (for example, RRC) configuration, or a network side device configuration.

For example, the first message is the composition information that is of the network function included in the radio service channel and that is included in the radio service channel configuration information. After the first function establishes the radio service channel, the composition information of the network function in the radio service channel may be represented based on a function combination and an identifier predefined in a protocol. If the protocol defines that {NF type 1, NF type 2, NF type 3} is function composition information of a radio service channel whose identifier is 1, and {NF type 1, NF type 2, NF type 3} is function composition information of a radio service channel whose identifier is 2, the information may be used to represent the function composition information of the corresponding radio service channel by using the identifier 1 or the identifier 2.

(32) The first request.

If the first function determines the first message according to the first request, the first message fed back by the first function may be consistent with information content included in the first request, that is, if information recommended in the request message is agreed, information such as a specific function composition and a specific function sequence of the radio service channel does not need to be sent again, thereby reducing signaling overheads.

S330. The first function receives a second message.

The second message is sent by the terminal after the terminal completes establishment, reconfiguration, or release of the radio service channel according to the received first message. Based on this, the second message includes at least one of the following (41) to (43).

(41) A radio service channel configuration complete message, used to indicate that the terminal has established a radio service channel corresponding to the radio service channel configuration information.

In an implementation, the radio service channel configuration complete message includes at least one of the following (410) to (414).

(410) An identifier of the terminal, used to indicate a sender of the message.

(411) An identifier of a network function instance, used to indicate an instance that carries a function of the radio service channel.

(412) Public land mobile network (PLMN) information of the terminal.

(413) Network slicing information of the terminal.

(414) Information about a non-access stratum (NAS) termination point of the terminal or information about another termination point other than the NAS termination point.

(42) A radio service channel reconfiguration complete message, used to indicate that the terminal has reconfigured a radio service channel corresponding to the radio service channel reconfiguration information.

For content included in the radio service channel reconfiguration complete message, refer to the foregoing related descriptions of the radio service channel configuration complete message. For example, the radio service channel reconfiguration complete message may include the identifier of the terminal, the identifier of the network function instance, and the like. To avoid repetition, details are not described herein again.

(43) A radio service channel reject message, used to indicate that the terminal has rejected the radio service channel configuration information or the radio service channel reconfiguration information.

The radio service channel reject message sent by the terminal may include at least one of the following (431) to (433):

(431) An identifier of the terminal, used to indicate a sender of the message.

(432) A cause for rejecting to establish or reconfigure the radio service channel.

(433) A first time, where the first time is used to indicate that time information of establishing or reconfiguring the radio service channel is acceptable to the terminal.

Correspondingly, when receiving the radio service channel reject message, the first function needs to reset a network function related to the radio service channel corresponding to the radio service channel reject message or a corresponding network resource.

Based on the foregoing descriptions of the method embodiment 300, the following further describes its implementation process with reference to Examples 1 to 3, and content is as follows:

### EXAMPLE 1

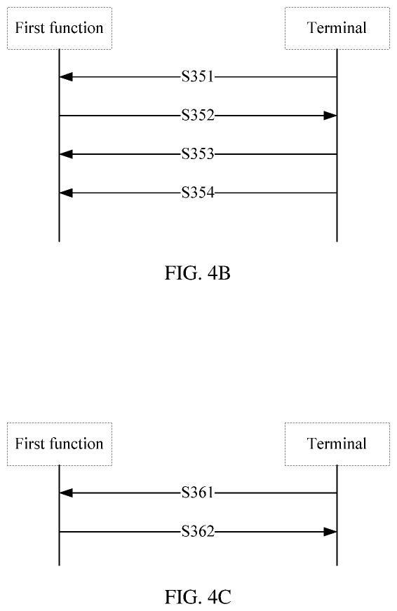

S341. With reference to FIG. 4A, a terminal sends a first request to a first function according to a cause or an event such as local information (for example, a power or personalized experience/service requirement), to request the first function to establish a radio service channel that meets a requirement of the terminal.

S342. The first function determines, according to the first request, a received radio service type or radio transmission quality requirement, context information of a network function, and the like, whether to establish a radio service channel and corresponding configuration information, and after determining and completing establishment of the radio service channel, sends a first message to the terminal, that is, radio service channel configuration information.

S343. If the terminal completes establishment of the radio service channel according to the radio service channel configuration information, the terminal sends a radio service channel configuration complete message (that is, a second message).

S344. If the terminal rejects to establish the radio service channel according to the radio service channel configuration information, the terminal sends a radio service channel reject message (that is, a second message) to the first function.

### EXAMPLE 2

S351. With reference to FIG. 4B, if a terminal is triggered according to a cause or event such as local information (for example, a power or personalized experience/service requirement), the terminal may send a first request to a first function, to request the first function to reconfigure a radio service channel that meets a requirement of the terminal.

S352. The first function determines, according to the first request, a received radio service type or radio transmission quality requirement, context information of a network function, and the like, whether to reconfigure the radio service channel, and after determining and completing reconfiguration of the radio service channel, sends a first message to the terminal, that is, radio service channel reconfiguration information.

S353. If the terminal completes reconfiguration of the radio service channel according to the radio service channel reconfiguration information, the terminal sends a radio service channel reconfiguration complete message (that is, a second message).

S354. If the terminal rejects to reconfigure the radio service channel according to the radio service channel configuration information, the terminal sends a radio service channel reject message (that is, a second message) to the first function.

### EXAMPLE 3

S361. With reference to FIG. 4C, if a terminal is triggered according to a cause or event such as local information (for example, a power or personalized experience/service requirement), the terminal may send a first request to a first function, to request the first function to release a radio service channel that meets a requirement of the terminal.

S362. The first function determines, according to the first request, a received radio service type or radio transmission quality requirement, context information of a network function, and the like, whether to release the radio service channel and corresponding configuration information. If the radio service channel and the corresponding configuration information need to be released, the first function releases the radio service channel and the corresponding configuration information.

It should be noted that for the first request, the first message, and the second message in the foregoing Example 1 to Example 3, refer to the foregoing related descriptions of the method embodiment 300. To avoid repetition, details are not described herein again.

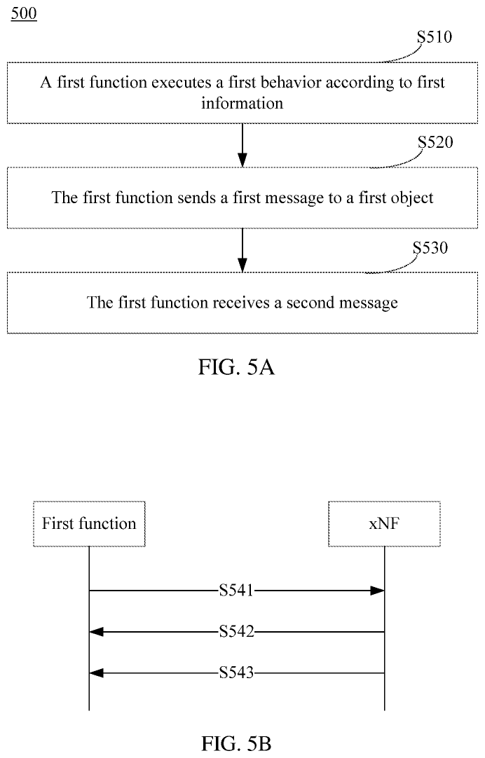

FIG. 5A is a schematic flowchart of a radio network service configuration method 500 according to an example embodiment of this application. The method 500 may be performed by, but not limited to, a network side device, and may be performed by hardware and/or software installed in the network side device. In this embodiment, the method 500 may include at least the following steps.

S510. A first function executes a first behavior according to first information.

The first function belongs to a first network function or a first network element, the first behavior includes at least one of establishing a radio service channel, reconfiguring a radio service channel, mapping the first information to an established radio service channel, or releasing a radio service channel, and the radio service channel includes at least one network function and/or at least one network function instance in a radio access network.

It can be understood that, for an implementation process of S510, refer to the foregoing related descriptions of the method embodiment 200 and/or 300. To avoid repetition, details are not described herein again.

S520. The first function sends a first message to a first object.

The first object includes a second network function and/or a second network element. Optionally, the first message may include at least one of the following (51) to (54):

(51) Radio service channel configuration information, used to indicate that the first function has established a radio service channel corresponding to the first information.

The radio service channel configuration information may include at least one of the following (5101) to (5105).

(5101) An identifier of the radio service channel, used to identify the radio service channel, for example, used by the first object to identify a radio service channel that needs to be established.

(5102) Information about a source network function (that is, a pre-order network function), where the source network function is used to indicate a network function of protocol data that the first object needs to receive in the radio service channel.

Optionally, the information about the source network function may be represented by using a network function type, a network function identifier, and/or a network function instance identifier.

(5103) Information about a target network function (that is, a post-order network function), where the target network function is used to indicate a network function of protocol data that is sent by the first object and that needs to be received in the radio service channel.

Optionally, the information about the target network function may be represented by using a network function type, a network function identifier, and/or a network function instance identifier.

(5104) Eighth indication information, where the eighth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel.

For example, “01” may represent increasing the quantity of network functions in the radio service channel, “10” may represent reducing the quantity of network functions in the radio service channel, and “00” may represent modifying one or more network functions in the radio service channel, and a quantity of network functions constituting the radio service channel changes or remains unchanged.

(5105) Nine indication information, where the ninth indication information is used to indicate a type of a service data unit carried on the radio service channel.

In an implementation, the type of the service data unit may be one or more of default, NAS signaling, an RRC message, a perception control message, perception data, a perception result, a digital twin control message, digital twin data, a data twin result, user plane data required by a quality of service requirement, and the like.

(52) Radio service channel reconfiguration information, used to indicate that the first function has reconfigured a radio service channel corresponding to the first information.

For an implementation process of the radio service channel reconfiguration information, refer to the foregoing related descriptions of the radio service channel configuration information in (51). To avoid repetition, details are not described herein again.

(53) Radio service channel mapping information, used to indicate a mapping relationship between the first information and an established radio service channel.

For example, assuming that a radio service channel that matches the first information exists in the established radio service channel, or that the reconfigured radio service channel can match the first information (for example, the user plane requirement information, the control plane requirement information, or the first request), the first function may map the first information to the established radio service channel or the reconfigured radio service channel, and use the mapping relationship as the radio service channel mapping information.

(54) Radio service channel release information, used to indicate that the first function has released a radio service channel corresponding to the first information.

The radio service channel release information may include at least an identifier of the radio service channel.

It can be understood that, similar to the method embodiment 300, before sending the first message to the first object, the first function may determine the first message according to second information. For an implementation process of the second information, refer to the foregoing related descriptions of the second information in the method embodiment 300. To avoid repetition, details are not described herein again.

S530. The first function receives a second message.

The second message includes at least one of the following (61) to (63):

(61) A radio service channel configuration complete message, used to indicate that the first object has established a radio service channel corresponding to the radio service channel configuration information, where the radio service channel configuration complete message sent by the first object includes at least one of the following:

(611) An identifier of the first object, used to indicate a sender of the message, such as a second network function or a second network element.

(612) An identifier of a network function instance in the first object, used to indicate an instance that carries a function of the radio service channel.

(62) A radio service channel reconfiguration complete message, used to indicate that the first object has reconfigured a radio service channel corresponding to the radio service channel reconfiguration information, where the radio service channel reconfiguration complete message sent by the first object includes at least one of the following (621) to (622).

(621) An identifier of the first object, used to indicate a sender of the message.

(622) An identifier of a network function instance in the first object, used to indicate an instance that carries a function of the radio service channel.

(63) A radio service channel reject message, used to indicate that the first object has rejected the radio service channel configuration information or the radio service channel reconfiguration information.

The radio service channel reject message sent by the first object includes at least one of the following (631) to (633).

(631) An identifier of the first object.

(632) A cause for rejecting to establish or reconfigure the radio service channel.

(633) A second time, where the second time is used to indicate that time information of establishing or reconfiguring the radio service channel is acceptable to the first object.

Based on the foregoing descriptions of the method embodiment 500, the following further describes its implementation process with reference to Examples 4 and 5.

### EXAMPLE 4

S541. With reference to FIG. 5B, a first function determines, according to a received radio service type or radio transmission quality requirement, to establish a radio service channel and corresponding configuration information, or determines to reconfigure a radio service channel, and after completing establishment or reconfiguration of the radio service channel, the first function sends a first message (for example, radio service channel configuration information or radio service channel reconfiguration information) to a first object, as shown by xNF in FIG. 5B.

S542. If the xNF completes establishment or reconfiguration of the radio service channel according to the received first message, the first object sends a radio service channel configuration complete message or a radio service channel reconfiguration complete message to the first function.

S543. If the first object rejects to establish or reconfigure the radio service channel according to the received first message, the first object sends a radio service channel reject message to the first function.

### EXAMPLE 5

When a network element in which a first function is located performs radio service channel control with another network element (for example, xNB shown in FIG. 5C), a process of interaction between the network element in which the first function is located and the another network element may be shown in FIG. 5C. It can be understood that, in a 6G application scenario, the network element in which the first function is located may provide a large-range radio service, and the another network element may be configured to provide a small-range radio service. The another network element performs air interface interaction with a terminal based on a radio service channel configured by the network element to which the first function belongs.

S551. A first function determines, according to a received radio service type or radio transmission quality requirement, and/or context information of a network function, to establish a radio service channel and/or reconfigure an established radio service channel within a service range served by an xNB. If the radio service channel is successfully established or reconfigured, the first function sends a first message (for example, radio service channel configuration information or radio service channel reconfiguration information) to a first object, as shown by xNB in FIG. 5C.

S552. After completing establishment of the radio service channel or reconfiguration of the radio service channel according to the first message, the xNB sends a radio service channel configuration complete message or a radio service channel reconfiguration complete message to the first function.

S553. If the xNB rejects to establish or reconfigure the radio service channel according to the first message, the xNB may send a radio service channel reject message to the first function.

S554. When the radio service channel is successfully established or reconfigured by the xNB, the xNB further needs to send a radio service channel configuration complete message or a radio service channel reconfiguration complete message to the terminal.

For a process of establishing or reconfiguring a service channel between the xNB and the terminal, the establishment/reconfiguration procedure described in the method embodiment 300 may be reused, or the xNB may exchange RSC establishment/reconfiguration information with the terminal. If RSC establishment/reconfiguration fails on a UE side, the xNB needs to report failure information to the network element or the network function in which the first function is located.

It should be noted that for the first request, the first message, and the second message in the foregoing Example 4 to Example 5, refer to the foregoing related descriptions of the method embodiment 300. To avoid repetition, details are not described herein again.

It should be noted that, in an implementation process of the radio network service configuration procedure, the method embodiment 300 and the method embodiment 500 may be separately implemented, or may be simultaneously implemented. For example, after the first function determines, according to the received radio service type or radio transmission quality requirement, to establish the radio service channel and the corresponding configuration information, or determines to reconfigure the radio service channel, the first function may simultaneously send the first message (for example, the radio service channel configuration information or the radio service channel reconfiguration information) to the terminal and the first object.

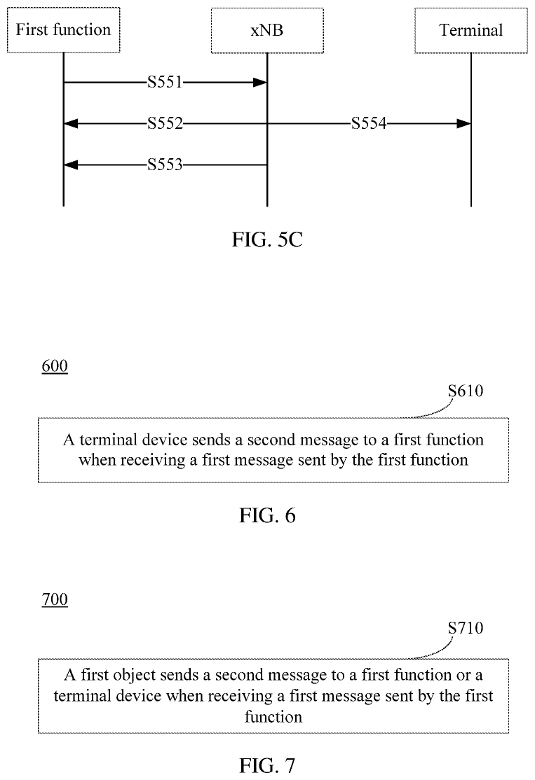

FIG. 6 is a schematic flowchart of a radio network service configuration method 600 according to an example embodiment of this application. The method 600 may be performed by, but is not limited to, a terminal, and may be performed by hardware and/or software installed in the terminal. In this embodiment, the method 600 may include at least the following step.

S610. A terminal sends a second message to a first function when receiving a first message sent by the first function.

The first function belongs to a first network function or a first network element, and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the terminal has established a radio service channel corresponding to the radio service channel configuration information; a radio service channel reconfiguration complete message, used to indicate that the terminal has reconfigured a radio service channel corresponding to the radio service channel reconfiguration information; or a radio service channel reject message, used to indicate that the terminal has rejected the radio service channel configuration information or the radio service channel reconfiguration information.

Optionally, the radio service channel configuration information includes at least one of the following: an identifier of the radio service channel; a quantity of network functions included in the radio service channel; a function composition supported by the radio service channel; a function sequence between network functions included in the radio service channel; whether the function sequence is a transmit end sequence or a receive end sequence; composition information of a network function included in the radio service channel; or fourth indication information, where the fourth indication information is used to indicate a type of a service data unit carried on the radio service channel.

Optionally, the radio service channel reconfiguration information includes at least one of the following: a quantity of network functions included in the radio service channel; fifth indication information, where the fifth indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; a variation of the quantity of network functions in the radio service channel; a function composition supported by the radio service channel; sixth indication information, where the sixth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or seventh indication information, where the seventh indication information is used to indicate a type of a service data unit carried on the radio service channel.

Optionally, the radio service channel release information includes at least an identifier of the radio service channel.

Optionally, the first information includes at least one of the following: user plane requirement information; control plane requirement information; context information of each network function in a radio access network; or a first request, where the first request is sent by the terminal to request the first function to establish a radio service channel, reconfigure a radio service channel, or release a radio service channel.

Optionally, the context information of the network function includes at least one of the following: a type of the network function; an identifier of the network function; an identifier of the network function instance; an identifier of a radio service channel, where the radio service channel is related to the network function; capability information of the network function; location information of the network function; or load information of the network function.

Optionally, the radio service channel configuration complete message or the radio service channel reconfiguration complete message includes at least one of the following: an identifier of the terminal; an identifier of a network function instance, where the network function is a network function that carries the radio service channel; PLMN information of the terminal; or information about a NAS termination point of the terminal or information about another termination point other than the NAS termination point.

Optionally, the radio service channel reject message includes at least one of the following: an identifier of the terminal; a cause for rejecting to establish or reconfigure the radio service channel; or a first time, where the first time is used to indicate that time information of establishing or reconfiguring the radio service channel is acceptable to the terminal.

Optionally, before the sending, by a terminal, a second message to a first function when receiving a first message sent by the first function, the method further includes: sending, by the terminal, a first request to the first function, where the first request is used to request the first function to establish a radio service channel, reconfigure a radio service channel, or release a radio service channel.

Optionally, in a case that the first request is used to request the first function to establish a radio service channel, the first request carries at least one of the following: an identifier of the terminal; a cause for requesting to establish the radio service channel; composition information of a network function included in the radio service channel that is requested to be established; a function sequence between network functions of the radio service channel that is requested to be established; or whether the function sequence is a transmit end sequence or a receive end sequence.

Optionally, in a case that the first request is used to request the first function to reconfigure a radio service channel, the first request carries at least one of the following: an identifier of the terminal; a cause for requesting to reconfigure the radio service channel; an identifier of the radio service channel that is requested to be reconfigured; a quantity of network functions included in the radio service channel that is requested to be reconfigured; a variation of the quantity of network functions in the radio service channel that is requested to be reconfigured; a function composition supported by the radio service channel; composition information of a network function included in the radio service channel that is requested to be reconfigured; a function sequence between network functions of the radio service channel that is requested to be reconfigured; whether the function sequence is a transmit end sequence or a receive end sequence of target data; first indication information, where the first indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; second indication information, where the second indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or third indication information, where the third indication information is used to indicate a type of a service data unit carried on the radio service channel.

Optionally, in a case that the first request is used to request the first function to release a radio service channel, the first request carries at least one of the following: an identifier of the terminal; a cause for requesting to release the radio service channel; or an identifier of the radio service channel that is requested to be released.

It can be understood that, for an implementation process of the implementations provided in the method embodiment 600, reference may be made to the related descriptions in the foregoing method embodiments 200 to 500, and a corresponding technical effect is achieved. To avoid repetition, details are not described herein again.

FIG. 7 is a schematic flowchart of a radio network service configuration method 600 according to an example embodiment of this application. The method 600 may be performed by, but not limited to, a first object (for example, a second network element or a second network function), and may be performed by hardware and/or software installed in the first object. In this embodiment, the method 600 may include at least the following step.

S710. A first object sends a second message to a first function or a terminal when receiving a first message sent by the first function.

The first object includes a second network function or a second network element.

The first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information.

The second message includes at least one of the following: a radio service channel configuration complete message, used to indicate that the first object has established a radio service channel corresponding to the radio service channel configuration information; a radio service channel reconfiguration complete message, used to indicate that the first object has reconfigured a radio service channel corresponding to the radio service channel reconfiguration information; or a radio service channel reject message, used to indicate that the first object has rejected the radio service channel configuration information or the radio service channel reconfiguration information.

Optionally, the radio service channel configuration information or the radio service channel reconfiguration information includes at least one of the following: an identifier of the radio service channel; information about a source network function, where the source network function is used to indicate a network function of protocol data that the first object needs to receive in the radio service channel; information about a target network function, where the target network function is used to indicate a network function of protocol data that is sent by the first object and that needs to be received in the radio service channel; eighth indication information, where the eighth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or ninth indication information, where the ninth indication information is used to indicate a type of a service data unit carried on the radio service channel.

Optionally, the radio service channel configuration complete message or the radio service channel reconfiguration complete message includes at least one of the following: an identifier of the first object; or an identifier of a function instance of the first object.

Optionally, the radio service channel release information includes at least an identifier of the radio service channel.

Optionally, the radio service channel reject message includes at least one of the following: an identifier of the first object; a cause for rejecting to establish or reconfigure the radio service channel; or a second time, where the second time is used to indicate that time information of establishing or reconfiguring the radio service channel is acceptable to the first object.

Optionally, the first information includes at least one of the following: user plane requirement information; control plane requirement information; context information of each network function in a radio access network; or a first request, where the first request is sent by the terminal to request the first function to establish a radio service channel, reconfigure a radio service channel, or release a radio service channel.

Optionally, the context information of the network function includes at least one of the following: a type of the network function; an identifier of the network function; an identifier of the network function instance; an identifier of a radio service channel, where the radio service channel is related to the network function; capability information of the network function; location information of the network function; or load information of the network function.

It can be understood that, for an implementation process of the implementations provided in the method embodiment 700, reference may be made to the related descriptions in the foregoing method embodiments 200 to 500, and a corresponding technical effect is achieved. To avoid repetition, details are not described herein again.

It should be noted that the radio network service configuration methods 200 to 500 provided in the embodiments of this application may be performed by a radio network service configuration apparatus, or a control module that is in the radio network service configuration apparatus and that is configured to perform the radio network service configuration method. In the embodiments of this application, an example in which the radio network service configuration apparatus performs the radio network service configuration method is used to describe the radio network service configuration apparatus provided in the embodiments of this application.

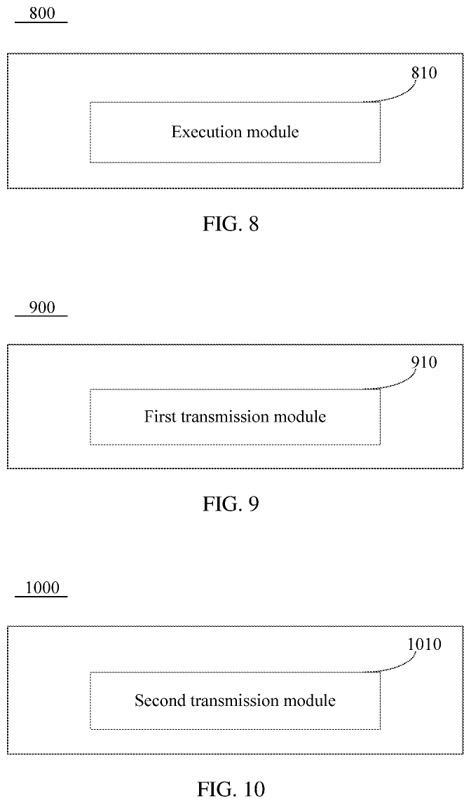

FIG. 8 is a schematic structural diagram of a radio network service configuration apparatus 800 according to an example embodiment of this application. The apparatus 800 includes an execution module 810, configured to execute a first behavior according to first information by using a first function, where the first function belongs to a first network function or a first network element, the first behavior includes at least one of establishing a radio service channel, reconfiguring a radio service channel, mapping the first information to an established radio service channel, or releasing a radio service channel, and the radio service channel includes at least one network function and/or at least one network function instance in a radio access network.

Optionally, the apparatus 800 further includes a first determining module, configured to determine the first information.

Optionally, the first information includes at least one of the following: user plane requirement information; control plane requirement information; context information of each network function in a radio access network; or a first request, where the first request is sent by a terminal to request the first function to establish a radio service channel, reconfigure a radio service channel, or release a radio service channel.

Optionally, the context information of the network function includes at least one of the following: a type of the network function; an identifier of the network function; an identifier of the network function instance; an identifier of a radio service channel, where the radio service channel is related to the network function; capability information of the network function; location information of the network function; or load information of the network function.

Optionally, the context information of the network function is implemented through a network repository function, where in a case that a core network and the radio access network are separately serviced, the network repository function belongs to the radio access network; or in a case that a core network and the radio access network are jointly serviced, the network repository function belongs to the core network.

Optionally, in a case that the first request is used to request the first function to establish a radio service channel, the first request carries at least one of the following: an identifier of the terminal; a cause for requesting to establish the radio service channel; composition information of a network function included in the radio service channel that is requested to be established; a function sequence between network functions of the radio service channel that is requested to be established; or whether the function sequence is a transmit end sequence or a receive end sequence.

Optionally, in a case that the first request is used to request the first function to reconfigure a radio service channel, the first request carries at least one of the following: an identifier of the terminal; a cause for requesting to reconfigure the radio service channel; an identifier of the radio service channel that is requested to be reconfigured; a quantity of network functions included in the radio service channel that is requested to be reconfigured; a variation of the quantity of network functions in the radio service channel that is requested to be reconfigured; a function composition supported by the radio service channel; composition information of a network function included in the radio service channel that is requested to be reconfigured; a function sequence between network functions of the radio service channel that is requested to be reconfigured; whether the function sequence is a transmit end sequence or a receive end sequence of target data; first indication information, where the first indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; second indication information, where the second indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or third indication information, where the third indication information is used to indicate a type of a service data unit carried on the radio service channel.

Optionally, in a case that the first request is used to request the first function to release a radio service channel, the first request carries at least one of the following: an identifier of the terminal; a cause for requesting to release the radio service channel; or an identifier of the radio service channel that is requested to be released.

Optionally, after the step pf executing, by a first function, a first behavior according to first information, the method further includes: sending, by the first function, a first message to a first object and/or the terminal, where the first object includes a second network function and/or a second network element; and the first message includes at least one of the following: radio service channel configuration information, used to indicate that the first function has established a radio service channel corresponding to the first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information.

Optionally, the radio service channel configuration information sent by the first function to the terminal includes at least one of the following: an identifier of the radio service channel; a quantity of network functions included in the radio service channel; a function composition supported by the radio service channel; a function sequence between network functions included in the radio service channel; whether the function sequence is a transmit end sequence or a receive end sequence; composition information of a network function included in the radio service channel; or fourth indication information, where the fourth indication information is used to indicate a type of a service data unit carried on the radio service channel.

Optionally, the radio service channel reconfiguration information sent by the first function to the terminal includes at least one of the following: a quantity of network functions included in the radio service channel; fifth indication information, where the fifth indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; a variation of the quantity of network functions in the radio service channel; a function composition supported by the radio service channel; sixth indication information, where the sixth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or seventh indication information, where the seventh indication information is used to indicate a type of a service data unit carried on the radio service channel.

Optionally, the radio service channel release information sent by the first function to the first object or the terminal includes at least an identifier of the radio service channel.

Optionally, the radio service channel configuration information or reconfiguration information sent by the first function to the first object includes at least one of the following: an identifier of the radio service channel; information about a source network function, where the source network function is used to indicate a network function of protocol data that the first object needs to receive in the radio service channel; information about a target network function, where the target network function is used to indicate a network function of protocol data that is sent by the first object and that needs to be received in the radio service channel; eighth indication information, where the eighth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or ninth indication information, where the ninth indication information is used to indicate a type of a service data unit carried on the radio service channel.

Optionally, the execution module 810 is configured to determine the first message according to second information by using the first function, where the second information includes at least one of the following: first configuration information, where the first configuration information is used for determining the first message, and the first configuration information is implemented through a protocol stipulation, an upper layer configuration, or a network side device configuration; or the first request.

Optionally, the apparatus 800 further includes a third transmission module, configured to receive a second message by using the first function, where the second message includes at least one of the following: a radio service channel configuration complete message, used to indicate that the first object or the terminal has established a radio service channel corresponding to the radio service channel configuration information; a radio service channel reconfiguration complete message, used to indicate that the first object or the terminal has reconfigured a radio service channel corresponding to the radio service channel reconfiguration information; or a radio service channel reject message, used to indicate that the first object or the terminal has rejected the radio service channel configuration information or the radio service channel reconfiguration information.

Optionally, the radio service channel configuration complete message or the radio service channel reconfiguration complete message sent by the terminal includes at least one of the following: an identifier of the terminal; an identifier of a network function instance; PLMN information of the terminal; and information about a NAS termination point of the terminal or information about another termination point other than the NAS termination point.

Optionally, the radio service channel reject message sent by the terminal includes at least one of the following: an identifier of the terminal; a cause for rejecting to establish or reconfigure the radio service channel; or a first time, where the first time is used to indicate that time information of establishing or reconfiguring the radio service channel is acceptable to the terminal.

Optionally, the radio service channel configuration complete message or the radio service channel reconfiguration complete message sent by the first object includes at least one of the following: an identifier of the first object; or an identifier of a network function instance in the first object.

Optionally, the radio service channel reject message sent by the first object includes at least one of the following: an identifier of the first object; a cause for rejecting to establish or reconfigure the radio service channel; or a second time, where the second time is used to indicate that time information of establishing or reconfiguring the radio service channel is acceptable to the first object.

FIG. 9 is a schematic structural diagram of a radio network service configuration apparatus 900 according to an example embodiment of this application. The apparatus 900 includes a first transmission module 910, configured to send a second message to a first function in a case that a first message sent by the first function is received, where the first function belongs to a first network function or a first network element, and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the terminal has established a radio service channel corresponding to the radio service channel configuration information; a radio service channel reconfiguration complete message, used to indicate that the terminal has reconfigured a radio service channel corresponding to the radio service channel reconfiguration information; or a radio service channel reject message, used to indicate that the terminal has rejected the radio service channel configuration information or the radio service channel reconfiguration information.

Optionally, the apparatus 900 further includes a second determining module, configured to determine the second message.

Optionally, the radio service channel configuration information includes at least one of the following: an identifier of the radio service channel; a quantity of network functions included in the radio service channel; a function composition supported by the radio service channel; a function sequence between network functions included in the radio service channel; whether the function sequence is a transmit end sequence or a receive end sequence; composition information of a network function included in the radio service channel; or fourth indication information, where the fourth indication information is used to indicate a type of a service data unit carried on the radio service channel.

Optionally, the radio service channel reconfiguration information includes at least one of the following: a quantity of network functions included in the radio service channel; fifth indication information, where the fifth indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; a variation of the quantity of network functions in the radio service channel; a function composition supported by the radio service channel; sixth indication information, where the sixth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or seventh indication information, where the seventh indication information is used to indicate a type of a service data unit carried on the radio service channel.

Optionally, the radio service channel release information includes at least an identifier of the radio service channel.

Optionally, the first information includes at least one of the following: user plane requirement information; control plane requirement information; context information of each network function in a radio access network; or a first request, where the first request is sent by the terminal to request the first function to establish a radio service channel, reconfigure a radio service channel, or release a radio service channel.

Optionally, the context information of the network function includes at least one of the following: a type of the network function; an identifier of the network function; an identifier of the network function instance; an identifier of a radio service channel, where the radio service channel is related to the network function; capability information of the network function; location information of the network function; or load information of the network function.

Optionally, the radio service channel configuration complete message or the radio service channel reconfiguration complete message includes at least one of the following: an identifier of the terminal; an identifier of a network function instance, where the network function is a network function that carries the radio service channel; PLMN information of the terminal; or information about a NAS termination point of the terminal or information about another termination point other than the NAS termination point.

Optionally, the radio service channel reject message includes at least one of the following: an identifier of the terminal; a cause for rejecting to establish or reconfigure the radio service channel; or a first time, where the first time is used to indicate that time information of establishing or reconfiguring the radio service channel is acceptable to the terminal.

Optionally, the first transmission module 910 is further configured to send a first request to the first function, where the first request is used to request the first function to establish a radio service channel, reconfigure a radio service channel, or release a radio service channel.

Optionally, in a case that the first request is used to request the first function to establish a radio service channel, the first request carries at least one of the following: an identifier of the terminal; a cause for requesting to establish the radio service channel; composition information of a network function included in the radio service channel that is requested to be established; a function sequence between network functions of the radio service channel that is requested to be established; or whether the function sequence is a transmit end sequence or a receive end sequence.

Optionally, in a case that the first request is used to request the first function to reconfigure a radio service channel, the first request carries at least one of the following: an identifier of the terminal; a cause for requesting to reconfigure the radio service channel; an identifier of the radio service channel that is requested to be reconfigured; a quantity of network functions included in the radio service channel that is requested to be reconfigured; a variation of the quantity of network functions in the radio service channel that is requested to be reconfigured; a function composition supported by the radio service channel; composition information of a network function included in the radio service channel that is requested to be reconfigured; a function sequence between network functions of the radio service channel that is requested to be reconfigured; whether the function sequence is a transmit end sequence or a receive end sequence of target data; first indication information, where the first indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; second indication information, where the second indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or third indication information, where the third indication information is used to indicate a type of a service data unit carried on the radio service channel.

Optionally, in a case that the first request is used to request the first function to release a radio service channel, the first request carries at least one of the following: an identifier of the terminal; a cause for requesting to release the radio service channel; or an identifier of the radio service channel that is requested to be released.

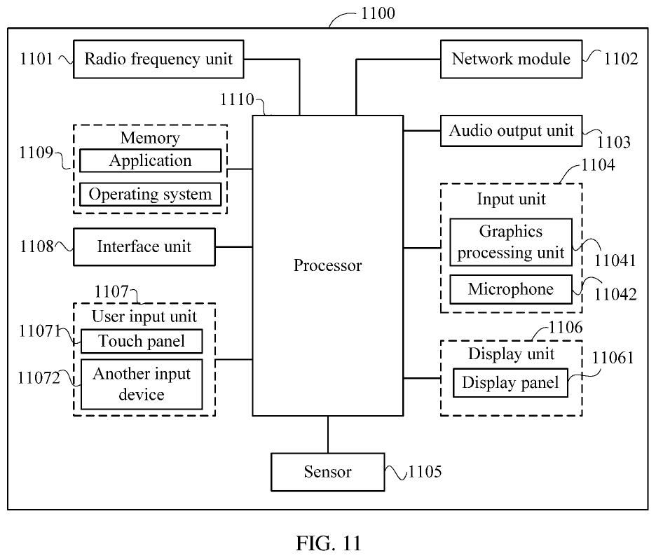

FIG. 10 is a schematic structural diagram of a radio network service configuration apparatus 1000 according to an example embodiment of this application. The apparatus 1000 includes a second transmission module 1010, configured to send a second message to a first function or a terminal in a case that a first message sent by the first function is received, where the first object includes a second network function or a second network element; and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the first object has established a radio service channel corresponding to the radio service channel configuration information; a radio service channel reconfiguration complete message, used to indicate that the first object has reconfigured a radio service channel corresponding to the radio service channel reconfiguration information; or a radio service channel reject message, used to indicate that the first object has rejected the radio service channel configuration information or the radio service channel reconfiguration information.

Optionally, the apparatus 1000 further includes a third determining module, configured to determine the second message.

Optionally, the radio service channel configuration information or reconfiguration information includes at least one of the following: an identifier of the radio service channel; information about a source network function, where the source network function is used to indicate a network function of protocol data that the first object needs to receive in the radio service channel; information about a target network function, where the target network function is used to indicate a network function of protocol data that is sent by the first object and that needs to be received in the radio service channel; eighth indication information, where the eighth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or ninth indication information, where the ninth indication information is used to indicate a type of a service data unit carried on the radio service channel.

Optionally, the radio service channel configuration complete message or the radio service channel reconfiguration complete message includes at least one of the following: an identifier of the first object; or an identifier of a function instance of the first object.

Optionally, the radio service channel release information includes at least an identifier of the radio service channel.

Optionally, the radio service channel reject message includes at least one of the following: an identifier of the first object; a cause for rejecting to establish or reconfigure the radio service channel; or a second time, where the second time is used to indicate that time information of establishing or reconfiguring the radio service channel is acceptable to the first object.

Optionally, the first information includes at least one of the following: user plane requirement information; control plane requirement information; context information of each network function in a radio access network; or a first request, where the first request is sent by the terminal to request the first function to establish a radio service channel, reconfigure a radio service channel, or release a radio service channel.

Optionally, the context information of the network function includes at least one of the following: a type of the network function; an identifier of the network function; an identifier of the network function instance; an identifier of a radio service channel, where the radio service channel is related to the network function; capability information of the network function; location information of the network function; or load information of the network function.

The radio network service configuration apparatuses 800 to 1000 in the embodiments of this application may be an apparatus, an apparatus having an operating system, an electronic device or a network side device, or may be a component, an integrated circuit, or a chip in a terminal or a network side device. The apparatus or the electronic device may be a mobile terminal, or a non-mobile terminal. For example, the mobile terminal may include but is not limited to the foregoing listed types of the terminal 11. The non-mobile terminal may be a server, a network attached storage (NAS), a personal computer (PC), a television (TV), a teller machine, or a self-service machine. This is not specifically limited in the embodiments of this application.

The radio network service configuration apparatus provided in this embodiment of this application can implement the processes implemented in the method embodiments in FIG. 2 to FIG. 5A, and achieve a same technical effect. To avoid repetition, details are not described herein again.

An embodiment of this application further provides a terminal, including a processor and a communication interface. The communication interface is coupled to the processor, and the processor is configured to run a program or an instruction to implement the steps of the method in the method embodiment 600. This terminal embodiment corresponds to the foregoing method embodiment on the terminal side. Each implementation process and implementation of the foregoing method embodiment may be applicable to this terminal embodiment, and a same technical effect can be achieved. FIG. 11 is a schematic diagram of a hardware structure of a terminal according to an embodiment of this application.

A terminal 1100 includes but is not limited to components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the terminal 1100 may further include the power supply (for example, a battery) that supplies power to each component. The power supply may be logically connected to the processor 1110 by using a power supply management system, so as to manage functions such as charging, discharging, and power consumption by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that, in this embodiment of this application, the input unit 1104 may include a graphics processing unit (GPU) 1041 and a microphone 11042, and the graphics processing unit 11041 processes image data of a still image or a video that is obtained by an image capturing apparatus (for example, a camera) in a video capturing mode or an image capturing mode. The display unit 1106 may include a display panel 11061. The display panel 11061 may be configured in a form such as a liquid crystal display or an organic light-emitting diode. The user input unit 1107 may include a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (for example, a volume control button or a power on/off button), a trackball, a mouse, and a joystick. Details are not described herein.

In this embodiment of this application, the radio frequency unit 1101 receives downlink data from a network side device and then sends the downlink data to the processor 1110 for processing; and sends uplink data to the network side device. Usually, the radio frequency unit 1101 includes but is not limited to an antenna, at least one amplifier, a transceiver, a coupler, a low noise amplifier, a duplexer, and the like.

The memory 1109 may be configured to store a software program or an instruction and various data. The memory 1109 may mainly include a program or instruction storage area and a data storage area. The program or instruction storage area may store an operating system, and an application or an instruction required by at least one function (for example, a sound playing function or an image playing function). In addition, the memory 1109 may include a high-speed random access memory, and may further include a non-volatile memory. The non-volatile memory may be a read-only memory (ROM), a programmable read-only memory PROM), an erasable programmable read-only memory (EPROM), an electrically erasable programmable read-only memory (EEPROM), or a flash memory, for example, at least one disk storage device, a flash memory device, or another non-volatile solid-state storage device.

The processor 1110 may include one or more processing units. Optionally, an application processor and a modem processor may be integrated into the processor 1110. The application processor mainly processes an operating system, a user interface, an application, an instruction, or the like. The modem processor mainly processes wireless communication, for example, a baseband processor. It can be understood that, alternatively, the modem processor may not be integrated into the processor 1110.

The radio frequency unit 1101 is configured to send a second message to a first function in a case that a first message sent by the first function is received, where the first function belongs to a first network function or a first network element, and the first message includes at least one of the following: radio service channel configuration information, used to indicate that the first function has established a radio service channel corresponding to first information; radio service channel reconfiguration information, used to indicate that the first function has reconfigured a radio service channel corresponding to the first information; radio service channel mapping information, used to indicate a mapping relationship between the first information and an established radio service channel; or radio service channel release information, used to indicate that the first function has released a radio service channel corresponding to the first information; and/or the second message includes at least one of the following: a radio service channel configuration complete message, used to indicate that the terminal has established a radio service channel corresponding to the radio service channel configuration information; a radio service channel reconfiguration complete message, used to indicate that the terminal has reconfigured a radio service channel corresponding to the radio service channel reconfiguration information; or a radio service channel reject message, used to indicate that the terminal has rejected the radio service channel configuration information or the radio service channel reconfiguration information.

Optionally, the radio service channel configuration information includes at least one of the following: an identifier of the radio service channel; a quantity of network functions included in the radio service channel; a function composition supported by the radio service channel; a function sequence between network functions included in the radio service channel; whether the function sequence is a transmit end sequence or a receive end sequence; composition information of a network function included in the radio service channel; or fourth indication information, where the fourth indication information is used to indicate a type of a service data unit carried on the radio service channel.

Optionally, the radio service channel reconfiguration information includes at least one of the following: a quantity of network functions included in the radio service channel; fifth indication information, where the fifth indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; a variation of the quantity of network functions in the radio service channel; a function composition supported by the radio service channel; sixth indication information, where the sixth indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or seventh indication information, where the seventh indication information is used to indicate a type of a service data unit carried on the radio service channel.

Optionally, the radio service channel release information includes at least an identifier of the radio service channel.

Optionally, the first information includes at least one of the following: user plane requirement information; control plane requirement information; context information of each network function in a radio access network; or a first request, where the first request is sent by the terminal to request the first function to establish a radio service channel, reconfigure a radio service channel, or release a radio service channel.

Optionally, the context information of the network function includes at least one of the following: a type of the network function; an identifier of the network function instance; an identifier of a radio service channel, where the radio service channel is related to the network function; capability information of the network function; location information of the network function; or load information of the network function.

Optionally, the radio service channel configuration complete message or the radio service channel reconfiguration complete message includes at least one of the following: an identifier of the terminal; an identifier of a network function instance, where the network function is a network function that carries the radio service channel; PLMN information of the terminal; or information about a NAS termination point of the terminal or information about another termination point other than the NAS termination point.

Optionally, the radio service channel reject message includes at least one of the following: an identifier of the terminal; a cause for rejecting to establish or reconfigure the radio service channel; or a first time, where the first time is used to indicate that time information of establishing or reconfiguring the radio service channel is acceptable to the terminal.

Optionally, the radio frequency unit 1101 is further configured to send a first request to the first function, where the first request is used to request the first function to establish a radio service channel, reconfigure a radio service channel, or release a radio service channel.

Optionally, in a case that the first request is used to request the first function to establish a radio service channel, the first request carries at least one of the following: an identifier of the terminal; a cause for requesting to establish the radio service channel; composition information of a network function included in the radio service channel that is requested to be established; a function sequence between network functions of the radio service channel that is requested to be established; or whether the function sequence is a transmit end sequence or a receive end sequence.

Optionally, in a case that the first request is used to request the first function to reconfigure a radio service channel, the first request carries at least one of the following: an identifier of the terminal; a cause for requesting to reconfigure the radio service channel; an identifier of the radio service channel that is requested to be reconfigured; a quantity of network functions included in the radio service channel that is requested to be reconfigured; a variation of the quantity of network functions in the radio service channel that is requested to be reconfigured; a function composition supported by the radio service channel; composition information of a network function included in the radio service channel that is requested to be reconfigured; a function sequence between network functions of the radio service channel that is requested to be reconfigured; whether the function sequence is a transmit end sequence or a receive end sequence of target data; first indication information, where the first indication information is used to indicate a network function reconfiguration type, and the network function reconfiguration type includes at least one of increasing a quantity of network functions in the radio service channel, reducing a quantity of network functions in the radio service channel, or modifying a network function in the radio service channel; second indication information, where the second indication information is used for indicating an information reconfiguration type, and the information reconfiguration type includes at least one of increasing a service data unit carried on the radio service channel, reducing a service data unit carried on the radio service channel, or modifying a service data unit carried on the radio service channel; or third indication information, where the third indication information is used to indicate a type of a service data unit carried on the radio service channel.

Optionally, in a case that the first request is used to request the first function to release a radio service channel, the first request carries at least one of the following: an identifier of the terminal; a cause for requesting to release the radio service channel; or an identifier of the radio service channel that is requested to be released.

An embodiment of this application further provides a network side device, including a processor and a communication interface. The communication interface is coupled to the processor, and the processor is configured to run a program or an instruction to implement the steps of the method embodiments 200, 300, 500, and 700. The network side device embodiment corresponds to the foregoing method embodiment of the network side device. Each implementation process and implementation of the foregoing method embodiment may be applicable to the network side device embodiment, and a same technical effect can be achieved.

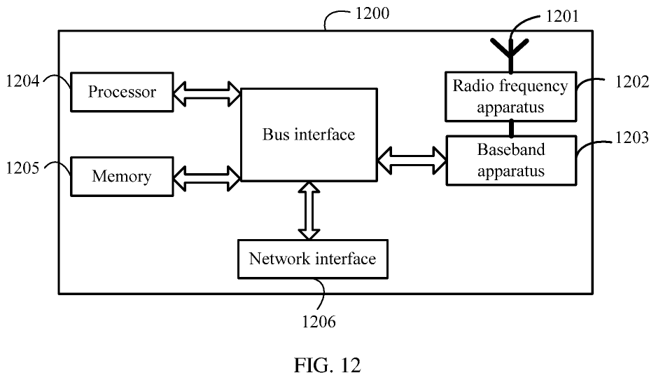

An embodiment of this application further provides a network side device. As shown in FIG. 12, a network device 1200 includes an antenna 1201, a radio frequency apparatus 1202, and a baseband apparatus 1203. The antenna 1201 is connected to the radio frequency apparatus 1202. In an uplink direction, the radio frequency apparatus 1202 receives information by using the antenna 1201, and sends the received information to the baseband apparatus 1203 for processing. In a downlink direction, the baseband apparatus 1203 processes information that needs to be sent, and sends processed information to the radio frequency apparatus 1202. The radio frequency apparatus 1202 processes the received information, and sends processed information by using the antenna 1201.

The band processing apparatus may be located in the baseband apparatus 1203. The method performed by the network side device in the foregoing embodiment may be implemented in the baseband apparatus 1203. The baseband apparatus 1203 includes a processor 1204 and a memory 1205.

The baseband apparatus 1203 may include, for example, at least one baseband board, where a plurality of chips are disposed on the baseband board. As shown in FIG. 12, one chip, for example, the processor 1204, is connected to the memory 1205, to invoke a program in the memory 1205 to perform the operations of the network device shown in the foregoing method embodiment.

The baseband apparatus 1203 may further include a network interface 1206, configured to exchange information with the radio frequency apparatus 1202. For example, the interface is a common public radio interface (CPRI).

For example, the network side device in this embodiment of the present application further includes an instruction or a program that is stored in the memory 1205 and executable on the processor 1204. The processor 1204 invokes the instruction or the program in the memory 1205 to perform the method performed by the modules shown in FIG. 6, and a same technical effect is achieved. To avoid repetition, details are not described herein again.

An embodiment of this application further provides a non-transitory readable storage medium. The non-transitory readable storage medium stores a program or an instruction, and the program or the instruction is executed by a processor to implement the processes in the foregoing radio network service configuration method embodiment, and a same technical effect can be achieved. To avoid repetition, details are not described herein again.

The processor is a processor in the terminal in the foregoing embodiment. The non-transitory readable storage medium includes a non-transitory computer readable storage medium, such as a read-only memory (ROM).

An embodiment of this application further provides a chip. The chip includes a processor and a communication interface, the communication interface is coupled to the processor, and the processor is configured to run a program or an instruction of a network side device to implement the processes of the foregoing radio network service configuration method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program product. The computer program product includes a processor, a memory, and a program or an instruction that is stored in the memory and executable on the processor, and the program or the instruction is executed by the processor to implement the processes of the foregoing radio network service configuration method embodiment, and a same technical effect can be achieved. To avoid repetition, details are not described herein again.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a non-transitory storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

What is claimed is:

1. A radio network service configuration method, comprising:
executing, by a first function, a first behavior according to first information, wherein
the first function belongs to a first network function or a first network element, the first behavior comprises at least one of establishing a radio service channel, reconfiguring a radio service channel, mapping the first information to an established radio service channel, or releasing a radio service channel, and the radio service channel comprises at least one network function and/or at least one network function instance in a radio access network.

2. The method according to claim 1, wherein the first information comprises at least one of the following:
user plane requirement information;
control plane requirement information;
context information of each network function in a radio access network; or
a first request, wherein the first request is sent by a terminal to request the first function to establish a radio service channel, reconfigure a radio service channel, or release a radio service channel.

3. The method according to claim 2, wherein the context information of the network function comprises at least one of the following:
a type of the network function;
an identifier of the network function;
an identifier of the network function instance;
an identifier of a radio service channel, wherein the radio service channel is related to the network function;
capability information of the network function;
location information of the network function; or
load information of the network function.

4. The method according to claim 3, wherein the context information of the network function is implemented through a network repository function, wherein
in a case that a core network and the radio access network are separately serviced, the network repository function belongs to the radio access network; or
in a case that a core network and the radio access network are jointly serviced, the network repository function belongs to the core network.

5. The method according to claim 2, wherein in a case that the first request is used to request the first function to establish a radio service channel, the first request carries at least one of the following:
an identifier of the terminal;
a cause for requesting to establish the radio service channel;
composition information of a network function comprised in the radio service channel that is requested to be established;
a function sequence between network functions of the radio service channel that is requested to be established; or
whether the function sequence is a transmit end sequence or a receive end sequence.

6. The method according to claim 2, wherein in a case that the first request is used to request the first function to reconfigure a radio service channel, the first request carries at least one of the following:
an identifier of the terminal;
a cause for requesting to reconfigure the radio service channel;
an identifier of the radio service channel that is requested to be reconfigured;
a quantity of network functions comprised in the radio service channel that is requested to be reconfigured;
a variation of the quantity of network functions in the radio service channel that is requested to be reconfigured;
a function composition supported by the radio service channel;
composition information of a network function comprised in the radio service channel that is requested to be reconfigured;
a function sequence between network functions of the radio service channel that is requested to be reconfigured;
whether the function sequence is a transmit end sequence or a receive end sequence of target data;
first indication information, wherein the first indication information is used to indicate a network function reconfiguration type, and the network function reconfiguration type comprises at least one of increasing a quantity of network functions in the radio service channel, reducing a quantity of network functions in the radio service channel, or modifying a network function in the radio service channel;
second indication information, wherein the second indication information is used for indicating an information reconfiguration type, and the information reconfiguration type comprises at least one of increasing a service data unit carried on the radio service channel, reducing a service data unit carried on the radio service channel, and modifying a service data unit carried on the radio service channel; or
third indication information, wherein the third indication information is used to indicate a type of a service data unit carried on the radio service channel.

7. The method according to claim 2, wherein in a case that the first request is used to request the first function to release a radio service channel, the first request carries at least one of the following:
an identifier of the terminal;
a cause for requesting to release the radio service channel; or
an identifier of the radio service channel that is requested to be released.

8. The method according to claim 1, wherein after the executing, by a first function, a first behavior according to first information, the method further comprises:
sending, by the first function, a first message to a first object and/or the terminal, wherein the first object comprises a second network function and/or a second network element; and
the first message comprises at least one of the following:
radio service channel configuration information, used to indicate that the first function has established a radio service channel corresponding to the first information;
radio service channel reconfiguration information, used to indicate that the first function has reconfigured a radio service channel corresponding to the first information;
radio service channel mapping information, used to indicate a mapping relationship between the first information and an established radio service channel; or
radio service channel release information, used to indicate that the first function has released a radio service channel corresponding to the first information.

9. The method according to claim 8, wherein the radio service channel configuration information sent by the first function to the terminal comprises at least one of the following:
an identifier of the radio service channel;
a quantity of network functions comprised in the radio service channel;
a function composition supported by the radio service channel;
a function sequence between network functions comprised in the radio service channel;
whether the function sequence is a transmit end sequence or a receive end sequence;
composition information of a network function comprised in the radio service channel; or
fourth indication information, wherein the fourth indication information is used to indicate a type of a service data unit carried on the radio service channel.

10. The method according to claim 8, wherein the radio service channel reconfiguration information sent by the first function to the terminal comprises at least one of the following:
a quantity of network functions comprised in the radio service channel;
fifth indication information, wherein the fifth indication information is used to indicate a network function reconfiguration type, and the network function reconfiguration type comprises at least one of increasing a quantity of network functions in the radio service channel, reducing a quantity of network functions in the radio service channel, or modifying a network function in the radio service channel;
a variation of the quantity of network functions in the radio service channel;
a function composition supported by the radio service channel;
sixth indication information, wherein the sixth indication information is used for indicating an information reconfiguration type, and the information reconfiguration type comprises at least one of increasing a service data unit carried on the radio service channel, reducing a service data unit carried on the radio service channel, or modifying a service data unit carried on the radio service channel; or
seventh indication information, wherein the seventh indication information is used to indicate a type of a service data unit carried on the radio service channel.

11. The method according to claim 8, wherein the radio service channel release information sent by the first function to the first object or the terminal comprises at least an identifier of the radio service channel.

12. The method according to claim 8, wherein the radio service channel configuration information or reconfiguration information sent by the first function to the first object comprises at least one of the following:
an identifier of the radio service channel;
information about a source network function, wherein the source network function is used to indicate a network function of protocol data that the first object needs to receive in the radio service channel;
information about a target network function, wherein the target network function is used to indicate a network function of protocol data that is sent by the first object and that needs to be received in the radio service channel;
eighth indication information, wherein the eighth indication information is used for indicating an information reconfiguration type, and the information reconfiguration type comprises at least one of increasing a service data unit carried on the radio service channel, reducing a service data unit carried on the radio service channel, or modifying a service data unit carried on the radio service channel; or
ninth indication information, wherein the ninth indication information is used to indicate a type of a service data unit carried on the radio service channel.

13. The method according to claim 8, wherein before the sending, by the first function, a first message to a first object and/or the terminal, the method further comprises:
determining, by the first function, the first message according to second information, wherein
the second information comprises at least one of the following:
first configuration information, wherein the first configuration information is used for determining the first message, and the first configuration information is implemented through a protocol stipulation, an upper layer configuration, or a network side device configuration; or
the first request.

14. The method according to claim 8, wherein after the sending, by the first function, a first message to a first object and/or the terminal, the method further comprises:
receiving, by the first function, a second message, wherein
the second message comprises at least one of the following:
a radio service channel configuration complete message, used to indicate that the first object or the terminal has established a radio service channel corresponding to the radio service channel configuration information;
a radio service channel reconfiguration complete message, used to indicate that the first object or the terminal has reconfigured a radio service channel corresponding to the radio service channel reconfiguration information; or
a radio service channel reject message, used to indicate that the first object or the terminal has rejected the radio service channel configuration information or the radio service channel reconfiguration information.

15. A radio network service configuration method, wherein the method comprises:
sending, by a terminal, a second message to a first function when receiving a first message sent by the first function, wherein
the first function belongs to a first network function or a first network element, and the first message comprises at least one of the following:
radio service channel configuration information, used to indicate that the first function has established a radio service channel corresponding to first information;
radio service channel reconfiguration information, used to indicate that the first function has reconfigured a radio service channel corresponding to the first information;
radio service channel mapping information, used to indicate a mapping relationship between the first information and an established radio service channel; or
radio service channel release information, used to indicate that the first function has released a radio service channel corresponding to the first information;
and/or
the second message comprises at least one of the following:
a radio service channel configuration complete message, used to indicate that the terminal has established a radio service channel corresponding to the radio service channel configuration information;
a radio service channel reconfiguration complete message, used to indicate that the terminal has reconfigured a radio service channel corresponding to the radio service channel reconfiguration information; or
a radio service channel reject message, used to indicate that the terminal has rejected the radio service channel configuration information or the radio service channel reconfiguration information.

16. The method according to claim 15, wherein the radio service channel configuration complete message or the radio service channel reconfiguration complete message comprises at least one of the following:
an identifier of the terminal;
an identifier of a network function instance, wherein the network function is a network function that carries the radio service channel;
public land mobile network PLMN information of the terminal; or
information about a non-access stratum NAS termination point of the terminal or information about another termination point other than the NAS termination point;
and/or
the radio service channel reject message comprises at least one of the following:
an identifier of the terminal;
a cause for rejecting to establish or reconfigure the radio service channel; or
a first time, wherein the first time is used to indicate that information of establishing or reconfiguring the radio service channel is acceptable to the terminal.

17. A radio network service configuration method, wherein the method comprises:
sending, by a first object, a second message to a first function or a terminal when receiving a first message sent by the first function, wherein
the first object comprises a second network function or a second network element; and
the first message comprises at least one of the following:
radio service channel configuration information, used to indicate that the first function has established a radio service channel corresponding to first information;
radio service channel reconfiguration information, used to indicate that the first function has reconfigured a radio service channel corresponding to the first information;
radio service channel mapping information, used to indicate a mapping relationship between the first information and an established radio service channel; or
radio service channel release information, used to indicate that the first function has released a radio service channel corresponding to the first information;
and/or
the second message comprises at least one of the following:
a radio service channel configuration complete message, used to indicate that the first object has established a radio service channel corresponding to the radio service channel configuration information;
a radio service channel reconfiguration complete message, used to indicate that the first object has reconfigured a radio service channel corresponding to the radio service channel reconfiguration information; or
a radio service channel reject message, used to indicate that the first object has rejected the radio service channel configuration information or the radio service channel reconfiguration information.

18. A network side device, comprising a processor, a memory, and a program or an instruction that is stored in the memory and executable on the processor, wherein the program or the instruction is executed by the processor to implement the radio network service configuration method according to claim 1.

19. A terminal, comprising a processor, a memory, and a program or an instruction that is stored in the memory and executable on the processor, wherein the program or the instruction is executed by the processor to implement the radio network service configuration method according to claim 15.

20. A network side device, comprising a processor, a memory, and a program or an instruction that is stored in the memory and executable on the processor, wherein the program or the instruction is executed by the processor to implement the radio network service configuration method according to claim 17.
